(19) United States
(12) Patent Application Publication
(10) Pub. No.: US 2004/0083168 A1
(43) Pub. Date: Apr. 29, 2004

(54) Payment system for cashless payment transactions

(76) Inventors: Rainer Kuth, Herzogenaurach (DE); Michael Pierer Von Esch, Erlangen (DE)

Correspondence Address: YOUNG & THOMPSON, 745 SOUTH 23RD STREET 2ND FLOOR, ARLINGTON, VA, 22202

(21) Appl. No.: 10/609,436

(22) Filed: Jul. 1, 2003

(30) Foreign Application Priority Data
Jul. 1, 2002 (DE) 102 29 477.1

(51) Int. Cl. G06F 17/60

(52) U.S. Cl. 705/40; 705/37

(57) ABSTRACT

A payment system for cashless payment transactions in trade, in which the customer uses his mobile phone or pager to prompt payment of the purchase sum from the creditor to the vendor, where the creditor transmits to the customer's mobile phone a TAN which can be transmitted by a mobile phone interface to a payment console belonging to the vendor, from where the TAN is transmitted, preferably via a fixed line, to the creditor, who, possibly following a check, immediately posts the payment sum for the vendor and informs the parties involved as appropriate.

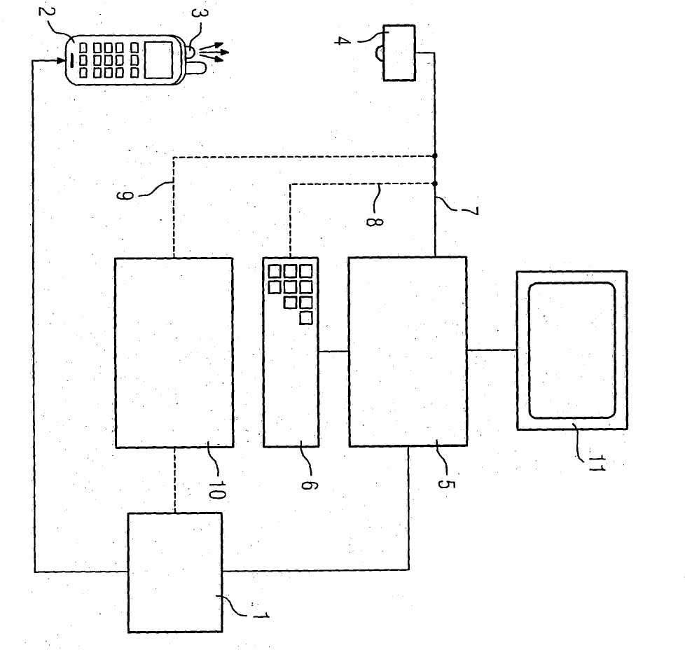

### FIELD OF THE INVENTION

The invention relates to a payment system for cashless payment transactions in trade, in which the customer uses his mobile phone or pager to prompt payment of the purchase sum from the creditor to the vendor.

### BACKGROUND OF THE INVENTION

A large number of different cashless payment systems have already been proposed to date, but these are either too insecure or else are too complicated and awkward to use, which means that they have not been able to be implemented for this reason. Besides the known credit card, as used, by way of example, for cashless payment of petty sums such as highway tolls or the like, there is also a system involving credit card and signature, which is used for paying sums which are large on average. However, the security of signatures against forgery is extremely limited.

In addition, a version which has even more security can be provided, namely credit card and signature and also a request to the creditor. This is chosen according to a random principle or for large sums, and also provides a high level of security. However, it requires a high level of staff involvement and the cycle time is very long. The simpler method of a credit card with a PIN, that is to say with a personal identification number, as used for withdrawing cash, still has considerable degrees of uncertainty as through the unprotected PINs, which are all too easily accessible to criminals today through appropriate card manipulation and the reading of stored data from the credit cards, however.

PINs and TANs (transaction numbers) have been used for more than ten years for telebanking in Deutsche Telekom's Btx system. This is a, by way of example, five-digit secret number which the customer uses to legitimize himself for requesting data. The creditor additionally supplies the customer with a list of “transaction numbers” which he needs to use to legitimize each individual transaction. Each TAN is invalid after it has been used once. However, this payment system is again highly involved, since the lists of the TANs, which are generated on the basis of a secret algorithm, are sent to the customer by mail.

One very secure payment system is the “paybox”. This involves the customer informing the vendor of his mobile phone number, and the vendor forwarding this mobile phone number together with the sum to the creditor, who sends an SMS to the customer on his mobile phone, whereupon the customer confirms the posting by returning a corresponding SMS. Although this method is extraordinarily secure, it presupposes an active radio link and requires a certain cycle time for the transfer and interaction between vendor and customer. In addition, the vendor is provided with the customer's mobile phone number, which the customer would sometimes like to keep anonymous. Input of the mobile phone number by the supplier also has opportunities for error.

### SUMMARY OF THE INVENTION

The invention is therefore based on the object of developing a payment system for cashless payment transactions such that it operates in a simple manner and is also simple to use, while having a high level of security.

The invention achieves this object by providing that the creditor transmits to the customer's mobile phone a TAN which can be transmitted by means of a mobile phone interface to a payment console belonging to the vendor, from where the TAN is transmitted, preferably via a fixed line, to the creditor, who, possibly following a check, immediately posts the payment sum for the vendor and informs the parties involved as appropriate.

The invention's transmission of a TAN to the customer's mobile phone means that the actual cashless payment operation is not made more complicated, since this transmission naturally takes place outside of a definite commercial transaction. The direct transmission of the TAN to the vendor's payment console and the transmission from said payment console to the creditor take place without a radio link, so that difficulties resulting therefrom which would greatly extend the payment operation or would even make it impossible cannot arise in the first place.

The TAN can be transmitted from the customer's mobile phone to the vendor's payment console using an infrared interface from the mobile phone to a payment console belonging to the supplier. This can be a till with an infrared interface or can be a keyboard with an infrared interface or can be an infrared interface on the PC. Instead of such an infrared interface, it is naturally also possible for a radio link to be provided, for example Blue Tooth. This radio link is naturally somewhat completely different than the radio network link between a mobile phone and the creditor. In this case, of course, this is just a locally limited radio link which is used instead of transmission via an infrared interface to transmit the TAN from the mobile phone to the payment console.

In this case, in one refinement of the invention, the arrangement can advantageously be in a form such that every payment operation is automatically followed by a new TAN being transmitted from the creditor to the customer's mobile phone, possibly with changed credit conditions.

A further provision entailing particular advantage can be that the creditor can activate particular blocking criteria, such as maximum sum per posting, maximum sum per vendor, maximum sum per time interval, maximum sum per sector, minimum time between two postings, or expiry date for the TAN, the blocking criteria preferably being transmitted with the TAN to the customer's mobile phone and being stored there. Such blocking criteria mean that performing the payment operation no longer requires that the creditor carry out any separate check other than for the correctness of the TAN, since the authorization using the TAN and the absence of any blocking criterion for the requested sum automatically prove creditworthiness, and hence the entire cashless payment operation can be performed particularly quickly.

In this context, it is finally also part of the invention that the mobile phone can store a plurality of TANS, which can each be retrieved individually once, for one or more creditors.

The inventive payment method is extremely secure because the data transmission from the creditor to the customer's mobile phone is extremely secure and additional security is provided by the TAN, which can be used only once, and by optional credit facilities. In addition, the inventive payment system is extraordinarily simple, however, since active radio links during the payment operation and reciprocal confirmation calls or SMSs are not required, in contrast to the paybox system.

### BRIEF DESCRIPTION OF THE DRAWINGS

Other advantages, features and details of the invention can be found in the description below of an exemplary embodiment and with reference to the drawing, which schematically shows a block diagram of the design of the inventive payment system.

### DETAILED DESCRIPTION OF THE INVENTION

First—and without any association with a previous transaction, merely to allow such a transaction—the creditor 1 transmits a TAN to a customer's mobile phone 2, which is provided with an infrared interface 3 which can interact with a corresponding infrared interface 4 in a vendor's shop. This infrared reception device 4 can be arranged either on the vendor's PC 5 or on the keyboard 6 of the vendor's PC, as indicated by the two lines 7 and 8. Alternatively, as indicated by the line 9, the infrared receiver 4 can be arranged on a till in the shop instead. 11 indicates a monitor.

The respective payment console, that is to say the PC 5, the keyboard 6 or the till 10, are again, and admittedly preferably, connected by means of telephone or another fixed line to the creditor 1 in order to communicate the billing sum and the TAN, transmitted by the mobile phone 2, to the creditor, who then immediately credits the corresponding sum to the vendor's account and debits it from the customer's account, with notification of this operation simultaneously being sent to both. In this case, the posting cannot be made until after a corresponding check by the creditor 1 or else can be made without such a check. For small sums, such a check is not absolutely necessary, since a certain creditworthiness has been documented by the already allocated TAN, of course. In addition, blocking criteria can very easily be activated by the credit institute either with the creditor or else in storage with the TAN in the customer's mobile phone, such as the aforementioned maximum sums per posting or else the expiry date for the TAN. This is because providing the TAN with a particular expiry date ensures that a TAN is not first used for a payment operation after some months, when the creditworthiness which existed months ago might not have existed for a long time. Blocking criteria such as the level of a one-off payment and the interval until the next payment allow a high level of security to be achieved for the bank involved in the system without any exact individual check.

The invention is not limited to the exemplary embodiment illustrated. It would thus also be possible, in particular, to implement the transmission between the mobile phone 2 and the reciprocal interface on the vendor's payment console in another way, for example using Blue Tooth or similar high-frequency radio transmissions, e.g. wireless LAN.

1. A payment system for cashless payment transactions in trade, in which the customer uses his mobile phone or pager to prompt payment of the purchase sum from the creditor to the vendor, wherein the creditor transmits to the customer's mobile phone a TAN which can be transmitted by means of a mobile phone interface to a payment console belonging to the vendor, from where the TAN is transmitted, preferably via a fixed line, to the creditor, who, possibly following a check, immediately posts the payment sum for the vendor and informs the parties involved as appropriate.

2. The payment system as claimed in claim 1, wherein the mobile phone or pager has an infrared transmitter or radio transmitter, e.g. Blue Tooth, for the payment console.

3. The payment system as claimed in claim 1, wherein the payment console comprises a till, a keyboard or a PC with a corresponding reciprocal interface.

4. The payment system as claimed in claim 1, wherein every payment operation is automatically followed by a new TAN being transmitted from the creditor to the customer's mobile phone.

5. The payment system as claimed in claim 1, wherein the creditor can activate particular blocking criteria, such as maximum sum per posting, maximum sum per vendor, maximum sum per time interval, maximum sum per sector, minimum time between two postings, or expiry date for the TAN.

6. The payment system as claimed in claim 5, the blocking criteria are stored with the TAN in the customer's mobile phone or pager.

7. The payment system as claimed in claim 1, wherein the mobile phone or pager can store a plurality of TANs, which can each be retrieved individually once, for one or more creditors.

8. The payment system as claimed in claim 2, wherein the payment console comprises a till, a keyboard or a PC with a corresponding reciprocal interface.

9. The payment system as claimed in claim 2, wherein every payment operation is automatically followed by a new TAN being transmitted from the creditor to the customer's mobile phone.

10. The payment system as claimed in claim 3, wherein every payment operation is automatically followed by a new TAN being transmitted from the creditor to the customer's mobile phone.

11. The payment system as claimed in claim 2, wherein the creditor can activate particular blocking criteria, such as maximum sum per posting, maximum sum per vendor, maximum sum per time interval, maximum sum per sector, minimum time between two postings, or expiry date for the TAN.

12. The payment system as claimed in claim 3, wherein the creditor can activate particular blocking criteria, such as maximum sum per posting, maximum sum per vendor, maximum sum per time interval, maximum sum per sector, minimum time between two postings, or expiry date for the TAN.

13. The payment system as claimed in claim 4, wherein the creditor can activate particular blocking criteria, such as maximum sum per posting, maximum sum per vendor, maximum sum per time interval, maximum sum per sector, minimum time between two postings, or expiry date for the TAN.

14. The payment system as claimed in claim 2, wherein the mobile phone or pager can store a plurality of TANs, which can each be retrieved individually once, for one or more creditors.

15. The payment system as claimed in claim 3, wherein the mobile phone or pager can store a plurality of TANs, which can each be retrieved individually once, for one or more creditors.

16. The payment system as claimed in claim 4, wherein the mobile phone or pager can store a plurality of TANs, which can each be retrieved individually once, for one or more creditors.

17. The payment system as claimed in claim 5, wherein the mobile phone, or pager can store a plurality of TANs, which can each be retrieved individually once, for one or more creditors.

18. The payment system as claimed in claim 6, wherein the mobile phone or pager can store a plurality of TANs, which can each be retrieved individually once, for one or more creditors.
